(19) United States
(12) Patent Application Publication
(10) Pub. No.: US 2013/0048449 A1
(43) Pub. Date: Feb. 28, 2013

(54) POSITIONING MECHANISM FOR A BICYCLE COOLING DEVICE

(71) Applicant: Wayne-Ian Moore, Changhua City (TW)

(72) Inventor: Wayne-Ian Moore, Changhua City (TW)

(21) Appl. No.: 13/220,697

(22) Filed: Aug. 30, 2011

(51) Int. Cl. F16D 65/847

(52) U.S. Cl. 188/264 R

(57) ABSTRACT

A cooling device for bicycles includes a cooling device and a ring, wherein the cooling device has a positioning hole and multiple recesses are located around the positioning hole. The ring is connected to the hub and multiple protrusions are located on the periphery of the ring. The recesses are located corresponding to the protrusions which are engaged with the recesses to secure the cooling device to the ring.

### BACKGROUND OF THE INVENTION

1. Field of the Invention

The present invention relates to a positioning mechanism, and more particularly to a positioning mechanism for a bicycle cooling device.

2. Description of Related Art

There are two types of conventional bicycle braking systems, one of which is the V-type braking system and another is the brake-disc braking system. The two types of bicycle braking systems have different advantages. The V-type braking system moves the braking pads to contact the wheel rim by pulling braking cables so as to stop the wheel. The brake-disc braking system is operated by either hydraulic power or mechanical power, wherein the hydraulic power drives the clamps via the operation levers, and the mechanical power uses wires to connect the operation levers and the clamps. The brake pads in the clamps clamp the brake disc on the axle of the wheel so as to stop the wheel.

When the brake pads in the clamps clamp the brake disc to stop the wheel, the friction between the brake pads and the brake disc generates high temperature which could deform the brake disc and the brake pads so that the life of the brake disc and the brake pads is shortened. If the braking action keeps working for a period of time, the brake disc and the brake pads are in the status of overheat and which will reduce the sensibility of the braking action. Even if the braking action is stopped, the temperature of the brake disc and the brake pads cannot be cooled down rapidly.

The present invention has arisen to mitigate and/or obviate the disadvantages of the conventional braking systems by providing a positioning mechanism for connecting the cooling device to the wheel so as to cool down the high temperature of the brake disc and the lining plates.

### SUMMARY OF THE INVENTION

The main objective of the present invention is to provide an improved positioning mechanism.

To achieve the objective, a positioning mechanism for a bicycle cooling device comprises a cooling device having a positioning hole and multiple recesses located around the positioning hole, a ring connected to an end of a hub and having multiple protrusions on a periphery thereof, the recesses located corresponding to the protrusions which are engaged with the recesses to secure the cooling device to the ring.

Furthermore, the cooling device has a chamber defined therein and the positioning hole is located at a center of the chamber, and the cooling device has an exit which communicates with the chamber. The positioning hole has multiple contact units located on a periphery thereof and the contact unit has a curved first plate and a curved second plate. The first and second plates curve toward each other. The first plate contacts a first side of the protrusion and the second plate contacts a second side of the protrusion so as to secure the cooling device to the ring.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view to show the parts of the first embodiment of the present invention;

FIG. 2 is a perspective view of the first embodiment of the present invention; and

FIG. 3 is a perspective view of the second embodiment of the present invention.

### DETAILED DESCRIPTION OF THE INVENTION

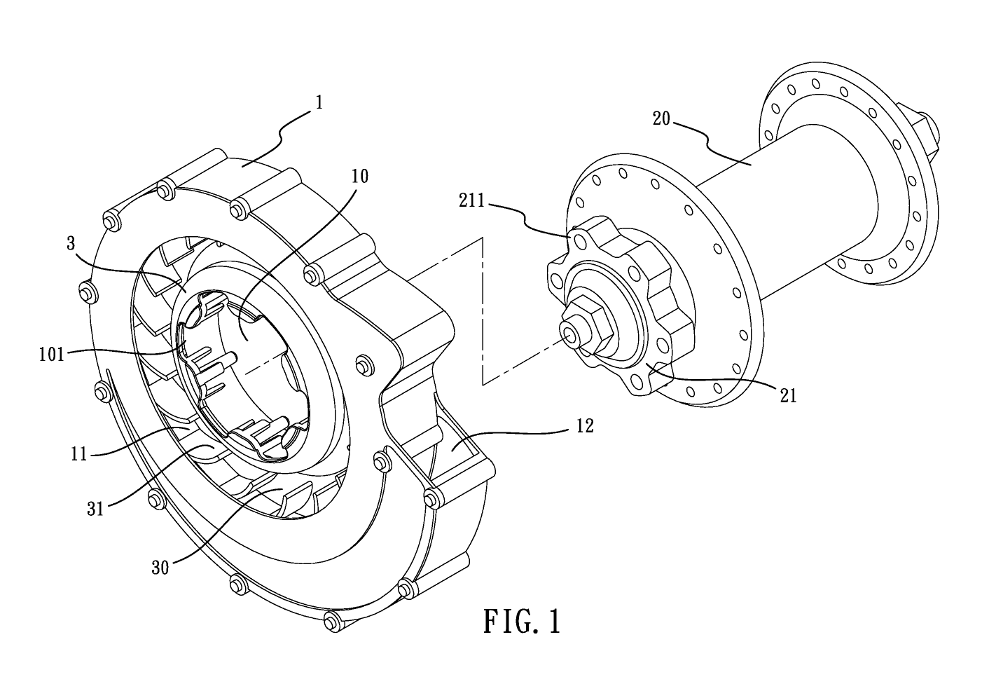

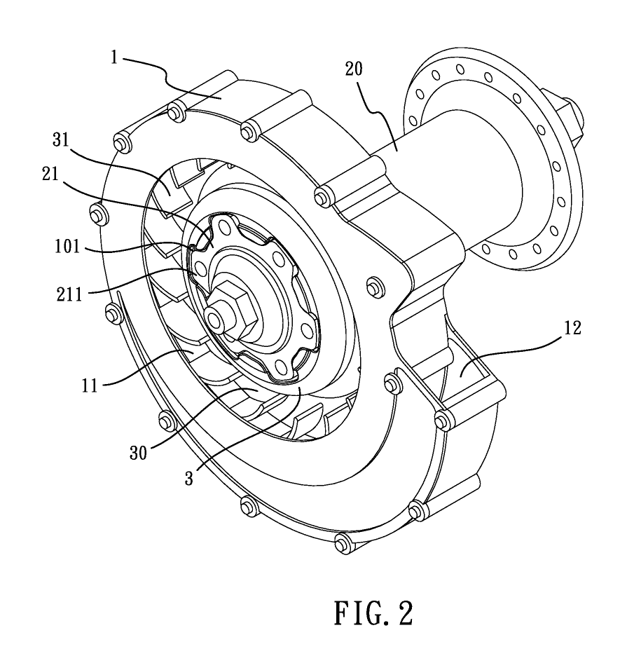

Referring to the drawings and initially to FIGS. 1 and 2, a positioning mechanism for a bicycle cooling device in accordance with the present invention under the first embodiment comprises a cooling device 1 and a ring 21. The cooling device 1 has a turbine unit 3 which has a positioning hole 10 defined in the center thereof. The turbine unit 3 has an annular groove 30 defined around the positioning hole 10 and multiple blades 31 are located around the annular groove 30. The blades 31 extend toward the positioning hole 10 so that when the turbine unit 3 is rotated in the cooling device 1, the annular groove 30 assists the thermo convection in the cooling device 1 by cooperating with the blades 31.

The cooling device 1 has a chamber 11 defined therein and the annular groove 30 is located in the chamber 11. The cooling device 1 has an exit 12 which communicates with the chamber 11. The turbine unit 3 has the positioning hole 10 at the center thereof and six recesses 101 are located around the positioning hole 10. The ring 21 is connected to an end of a hub 20 and has six protrusions 211 on the periphery thereof. The recesses 101 are located corresponding to the protrusions 211 which are engaged with the recesses 101 to secure the cooling device 1 to the ring 21. When the bicycle is running, the ring 21 on the hub 20 is rotated and drives the turbine unit 3 so that the cooling device 1 brings the thermal energy into the chamber 11 and the thermal convection brings the high temperature away. The bicycle wheel spins at high speed during operation of the bicycle so that the cooling device 1 secured on the ring 21 does not drop relative to the hub 20.

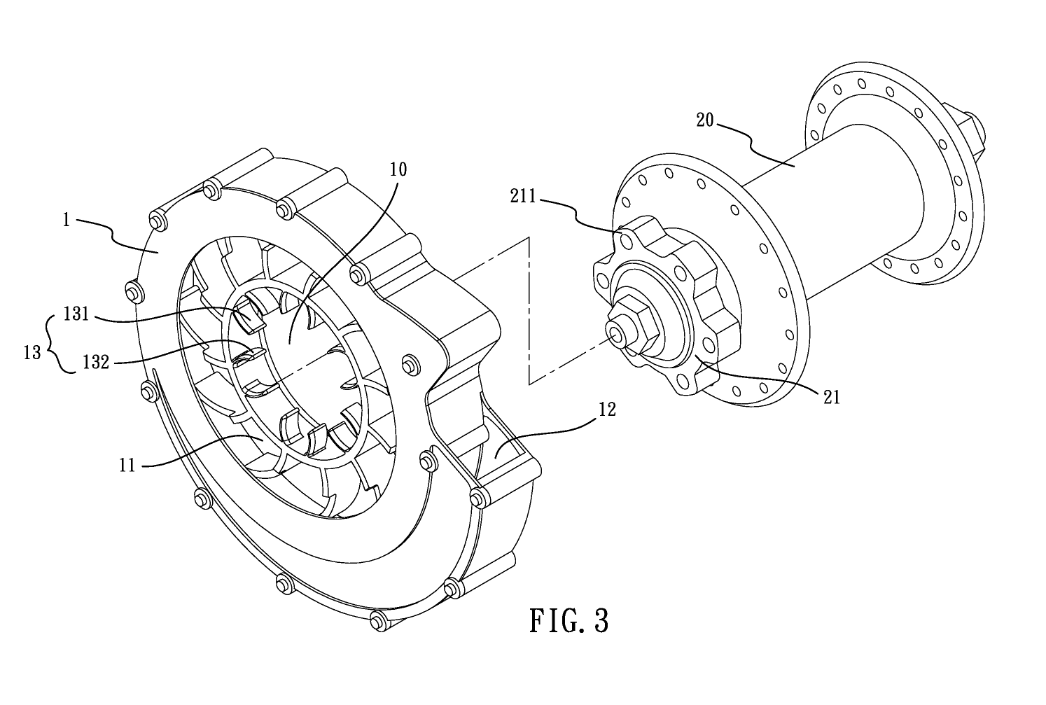

The cooling device 1 can be connected with the hubs 20 with different structure, as shown in FIG. 3, the second embodiment of the present invention is similar to the first embodiment, wherein the positioning hole 10 has six contact units 13 located on the periphery thereof and the contact units 13 are located corresponding to six protrusions 211. Each contact unit 13 has a curved first plate 131 and a curved second plate 132, the first and second plates 131, 132 curve toward each other. The curved first and second plates 131, 132 have two points where forces are applied according to the positions for accommodating the protrusions 211. One of the force applied points is the convex point and the other force applied point is on the top of the plate. The different protrusions 211 are positioned at different positions and the plates 131, 132 apply forces to the protrusions 211. The first plate 131 contacts the first side of the protrusion 211 and the second plate 132 contacts the second side of the protrusion 211. The two respective forces that the first and second plates 131, 132 are applied to the protrusions 211 are in opposite directions so as to secure the cooling device 1 to the ring 21.

The protrusions and recesses mentioned in the embodiments can be varied and the connection can be magnetic or clamping relationships. The point of the present invention is to secure the cooling device to the hub.

The hubs 20 of the front and rear wheels of a bicycle are equipped with a ring 21 which is rotated by the rotation of the hub 20 and generates thermal energy. The thermal energy is accumulated during the rotation of the wheels so that the parts of the bicycle may slightly inflate so that the cooling devices 1 on the rings 21 can cool the parts of the bicycle. The thermal energy is released by the chamber 11 that is large enough to provide better thermal convection. Therefore, the cooling device 1 that is secure to the hub 21 prevents the cooling device 1 from dropping relative to the ring 21 when the ring 21 spins at high speed.

Although the invention has been explained in relation to its preferred embodiment, it is to be understood that many other possible modifications and variations can be made without departing from the spirit and scope of the invention as hereinafter claimed.

What is claimed is:

1. A positioning mechanism for a bicycle cooling device, comprising:
a cooling device having a positioning hole and multiple recesses located around the positioning hole; and
a ring connected to an end of a hub and having multiple protrusions on a periphery thereof, the recesses located corresponding to the protrusions which are engaged with the recesses to secure the cooling device to the ring.

2. The positioning mechanism for a bicycle cooling device as claimed in claim 1, wherein the cooling device has a chamber defined therein and the positioning hole is located at a center of the chamber, and the cooling device has an exit which communicates with the chamber.

3. The positioning mechanism for a bicycle cooling device as claimed in claim 1, wherein the positioning hole has multiple contact units located on a periphery thereof and the contact unit has a curved first plate and a curved second plate; the first and second plates curve toward each other; the first plate contacts a first side of the protrusion and the second plate contacts a second side of the protrusion so as to secure the cooling device to the ring.
